(19) United States
(12) Patent Application Publication
(10) Pub. No.: US 2017/0270205 A1
(43) Pub. Date: Sep. 21, 2017

(54) Method for Divisionally Displaying Search Engine Results Page and Web Pages Therefrom

(71) Applicant: Gary Kung, Taipei City (TW)

(72) Inventor: Gary Kung, Taipei City (TW)

(73) Assignee: I/O INTERCONNECT, LTD., Santa Ana, CA (US)

(21) Appl. No.: 15/213,363

(22) Filed: Jul. 18, 2016

Related U.S. Application Data
(63) Continuation-in-part of application No. 15/076,640, filed on Mar. 21, 2016.

(51) Int. Cl. G06F 17/30; G10L 15/08; G06F 3/0481

(52) U.S. Cl. CPC G06F 17/30864; G06F 3/0481; G10L 15/08

(57) ABSTRACT

The method includes the steps of: a) inputting a word to be searched to a computer with a microphone; b) dividing a screen of the computer into at least two partitions; c) displaying a screen picture of a search engine results page (SERP) on a first partition of the at least two partitions; d) speaking a hyperlink in the SERP; and e) showing a web page of the hyperlink spoken in step d) on a second partition of the at least two partitions.

### BACKGROUND OF THE INVENTION

### 1. Technical Field

The invention relates to web search, particularly to displaying screen pictures of a search engine results page and web pages therefrom.

### 2. Related Art

A web search engine is a software system that is designed to search for information on the World Wide Web. The search results are generally presented in a list of results often referred to as search engine results pages (SERPs). The results are normally ranked by relevance to the query. Each result displayed on the SERP normally includes a title, a link that points to the actual page on the Web, and a short description showing where the search keywords have matched content within the page.

When a user makes a web search using a personal computer, such as a desktop or laptop computer with a wide monitor, more than half area of the SERP is blank or truncated due to limited monitor height. In other words, the effective information of the SERP only occupies the left side of the web page, and a blank space remains in the right side. The screen picture will change to a web page after a user clicks one of the hyperlinks in the SERP. If the user wants to review the original SERP, he or she needs to make an operation of return. That is, the SERP and the web page hyperlinked from the SERP cannot be shown on the monitor simultaneously. This is a poor utilization of displayable area of monitor, and it is inconvenient for users. Such wasted displayable areas could be effectively utilized. However, there is no solution on the market yet.

### SUMMARY OF THE INVENTION

An object of the invention is to provide a method for divisionally displaying a search engine results page and web pages therefrom, which can automatically utilize the whole displayable area of a monitor to display an SERP and multiple web pages hyperlinked therefrom. Thus the displayable area of an external monitor will not be wasted while permitting users to simultaneously view an SERP and web pages.

To accomplish the above said object, the method for divisionally displaying a search engine results page and web pages therefrom of the invention includes the steps of:

a) inputting a word to be searched to a computer with a microphone;

b) dividing a screen of the computer into at least two partitions;

c) displaying a screen picture of a search engine results page on a first partition of the at least two partitions;

d) speaking a hyperlink in the search engine results page; and

e) showing a web page of the hyperlink spoken in step d) on a second partition of the at least two partitions.

### BRIEF DESCRIPTION OF THE DRAWINGS

FIG. 1 is a schematic view of hardware arrangement of the invention; and

FIG. 2 is a flowchart of the method of the invention.

### DETAILED DESCRIPTION OF THE INVENTION

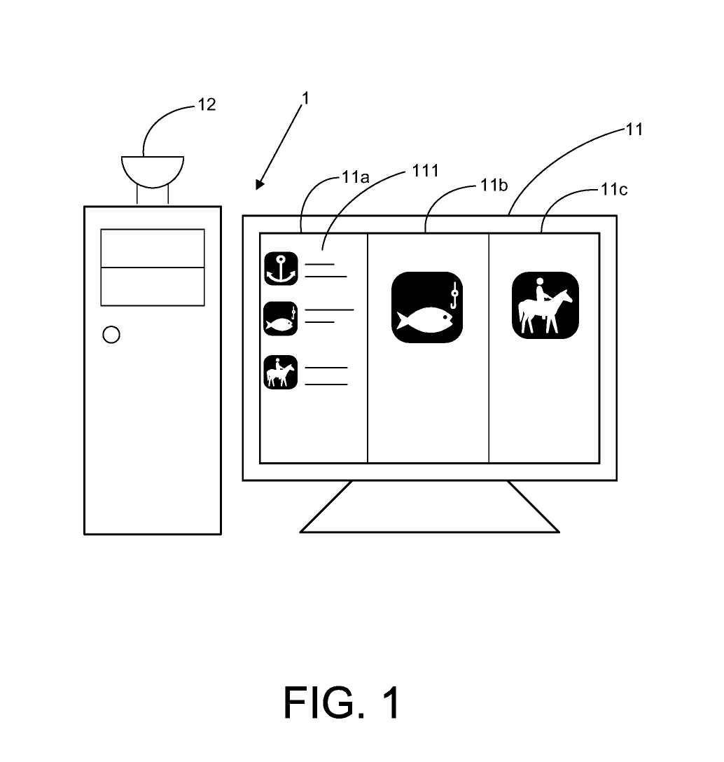

Please refer to FIG. 1. The invention provides a method for divisionally displaying a search engine results page (SERP) and web pages therefrom. Preferably, the method is performed in a personal computer 1, such as a desktop or laptop computer with a monitor 11. Additionally, the personal computer 1 is provided with a microphone 12 to receive audio signals.

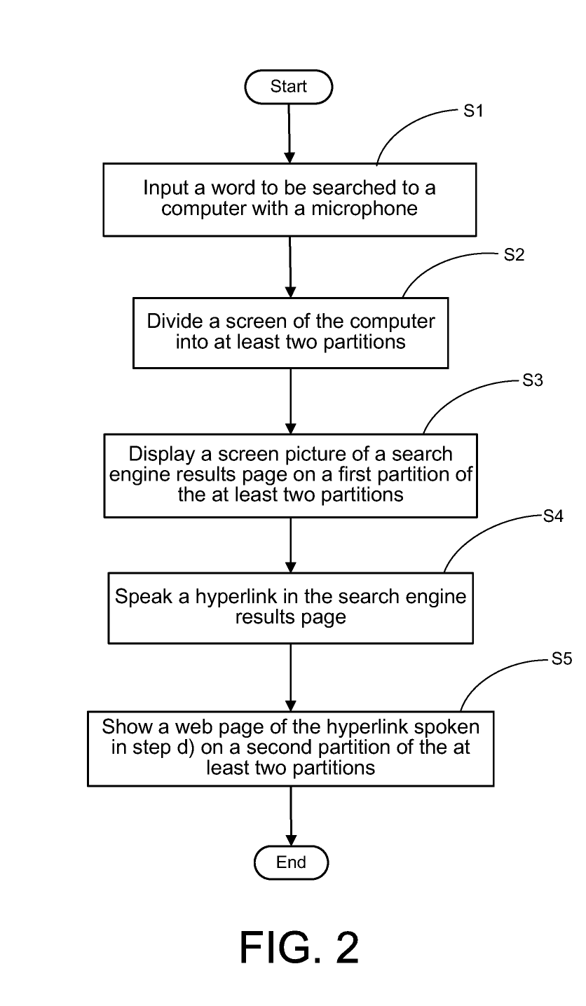

Please refer to FIG. 2, which shows a flowchart of the method of the invention. In step S1, a user inputs a word to be searched to the personal computer 1. This step can be implemented by voice through the microphone 12. Alternatively, keyboard input is also available. It is assumed the personal computer 1 has to be connected to internet. Additionally, a proprietary software application is installed in the personal computer 1.

In step S2, the proprietary software application in the personal computer 1 divides a screen of the monitor 11 of the personal computer 1 into at least two partitions, for example as shown in FIG. 1, three partitions 11a, 11b, 11c, namely, a first partition 11a, a second partition 11b and a third partition 11c. The partitions 11a, 11b, 11c can be either upright or horizontal. Preferably, upright partitions are more proper than horizontal partitions because the monitor is horizontally mounted on a table or wall usually.

In step S3, the software application in the personal computer 1 displays a screen picture of a search engine results page (SERP) 111 on the first partition 11a. Preferably, the second partition 11b and the third partition 11c may display web pages of top two or any two of the SERP. The SERP 111 is in response to the searching request in step S1. In the shown embodiment, the first partition 11a is at the leftmost position of the monitor 11. It is an arrangement which is in accordance with human visual practice, but any other position is still available. Each result displayed on the SERP 111 normally includes a picture or title, a hyperlink that points to the actual page on the Web and a short description showing where the keywords have matched content within the page.

In step S4, a user speaks one of the hyperlinks shown in the SERP 111. Presumably, the hyperlink spoken by the user must be the one he or she is interested in.

Finally, in step S5, the software application in the personal computer 1 shows a web page of the hyperlink spoken in step S4 on the second partition 11b as shown in FIG. 1. If a user repeats step S4 to speak another hyperlink, then a new web page of the latter hyperlink spoken will be shown on the third partition 11c.

To sum up, by the method of the invention, an SERP and the web pages selected by a user can be simultaneously displayed on a monitor 11. This is very helpful for general users.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for divisionally displaying a search engine results page and web pages therefrom, comprising:
a) inputting a word to be searched to a computer with a microphone;
b) dividing a screen of the computer into at least two partitions;
c) displaying a screen picture of a search engine results page (SERP) on a first partition of the at least two partitions;
d) speaking a hyperlink in the SERP; and
e) showing a web page of the hyperlink spoken in step d) on a second partition of the at least two partitions.

2. The method of claim 1, wherein the at least two partitions are arranged upright.

3. The method of claim 1, wherein the first partition is at the leftmost position of the screen.

4. The method of claim 1, wherein a web page of one of the SERP is displayed on a second partition in step c).
